(19) United States
(12) Patent Application Publication
(10) Pub. No.: US 2012/0152173 A1
(43) Pub. Date: Jun. 21, 2012

(54) Apparatus for feeding wildlife especially deer

(76) Inventor: James W. Campbell, Akron, NY (US)

(21) Appl. No.: 12/928,866

(22) Filed: Dec. 21, 2010

(51) Int. Cl. A01K 1/10

(52) U.S. Cl. 119/58; 119/60

(57) ABSTRACT

A holder for a block of feed is provided by a wire cage having criss-cross wires defining a back, a bottom, a side, a top, and an open front for the cage through which the wildlife can access the block of feed. The cage mounts the feed a desired distance above ground level on a stake placed in the ground and having a closed top end. The cage has a receptacle for the stake extending along and rearwardly from the wires forming the back of the receptacle. The stake receptacle extends along the entire length of the back and has a cross-section complementary to the cross-section of the stake so that a firm support for the receptacle and the block of feed contained therein is provided without the need for nailing the receptacle to the side of a tree or an existing structure, thus enabling the feed to be placed wherever desired to facilitate feeding of the animals or observing the animals while feeding especially for game harvesting applications.

The present invention relates to apparatus for feeding wildlife, especially deer, and particularly for mounting or supporting a body of animal feed where and when desired for feeding, observing, animal husbandry, harvesting, and/or other wildlife control applications.

Animal feed has been provided in various shaped bodies and blocks to facilitate feeding. A description of such blocks and the apparatus for fabricating them may be found in Lush et al., U.S. Pat. No. 5,855,943, issued Jan. 5, 1999. Wire cages have been used for supporting blocks of feed as for example shown in Wilkins, U.S. Pat. No. 5,826,541, issued Oct. 27, 1998. Such feed bodies have been nailed or otherwise hung and attached to structures in the woods, such as trees, or elsewhere where the animals feed. See for example Weil, U.S. Pat. No. 1,009,361, issued Nov. 21, 1911 and White, U.S. Pat. No. 1,092,314, issued Apr. 7, 1914. Other attachment methods have been by means of special hangers on tree limbs and the like, as shown, for example, in Hume, U.S. Design Pat. No. 194,610, issued Feb. 19, 1963 and Schneider, U.S. Pat. No. 5,052,342, issued Oct. 1, 1991.

It is desirable to locate the animal feed bodies easily and rapidly at desired locations, as in clearings, and without the need to find a tree or other mounting structure. Then, the animals will be attracted in proximity to where they may be observed or where they may be fed for animal husbandry, harvesting, and other applications in the vicinity of hunting blinds or away from populated areas.

To achieve flexibility in wild animal feeding and especially the feeding of deer and to locate feeding sites as where and when desired, the present invention provides a wire cage receptacle for holding a body of feed which can readily be mounted on a stake for which can be provided as an assembly with a stake. The stake is received in a stake receiving receptacle on the back of the wire cage which holds the body of feed. This receptacle may be another wire cage open at the bottom and closed at the top and having a cross-section complimentary to the cross-section of the stake and extending the entire length of the animal feed block receptacle cage. When the stake is in its receptacle, the cage is held above ground level at a desired height to facilitate animal feeding, observation of the animals, and access to the animal while feeding in a location, which is necessary or desirable for animal husbandry and animal harvesting purposes.

The present invention also provides a method for holding a body of animal feed which comprises the steps of providing a member, such as a shaft, having two opposing ends, providing an assembly having a first receptacle for receiving a body of animal feed and a second receptacle, coupled to the first receptacle, for receiving a first end of the member, and mounting the second end of the member into the ground in which the length of the member is sufficient to locate the first receptacle at a desired height above the ground.

The foregoing and other objects, features and advantages of the invention will become more apparent from a reading of the following description in connection with the accompanying drawings in which:

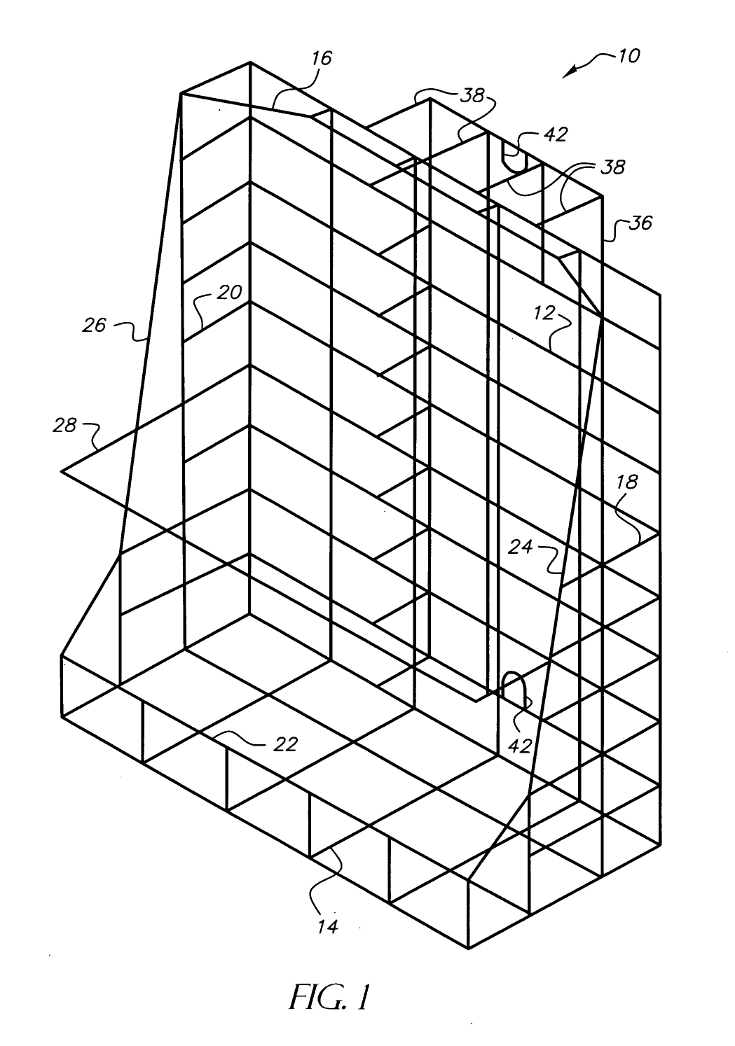

FIG. 1 is a perspective view of a wire cage holder for a block of animal feed in accordance with the invention;

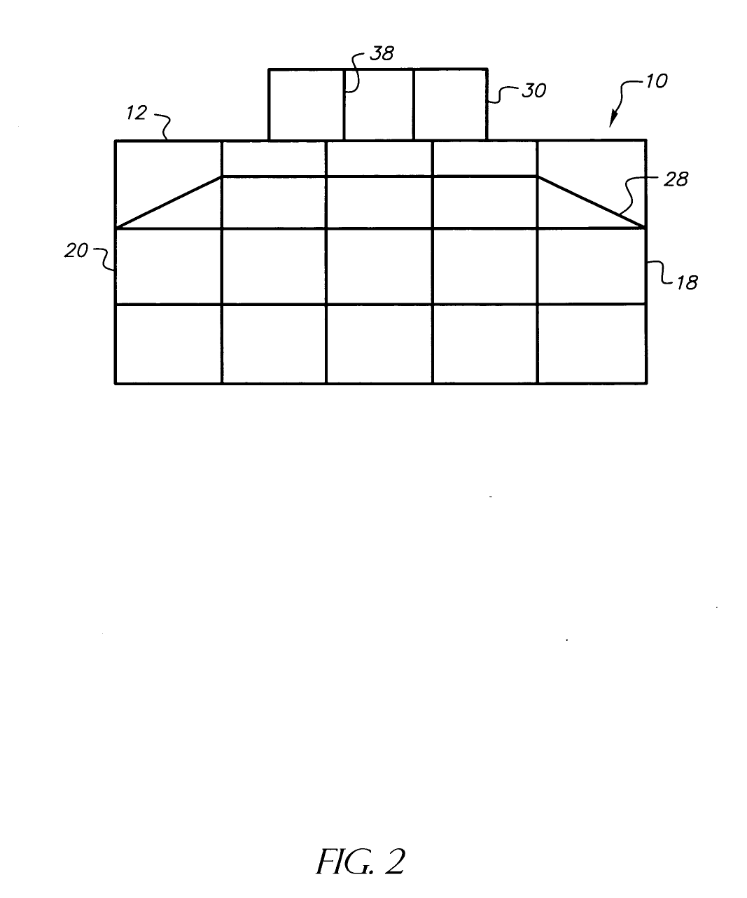

FIG. 2 is a top view of the holder shown in FIG. 1;

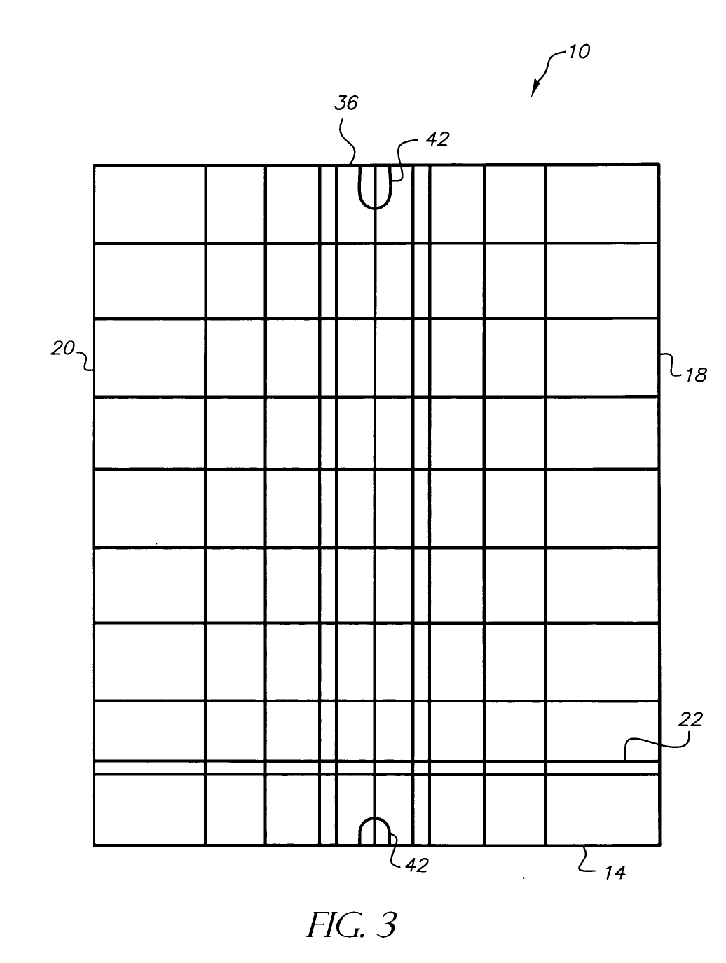

FIG. 3 is a front view of the holder shown in FIGS. 1 and 2;

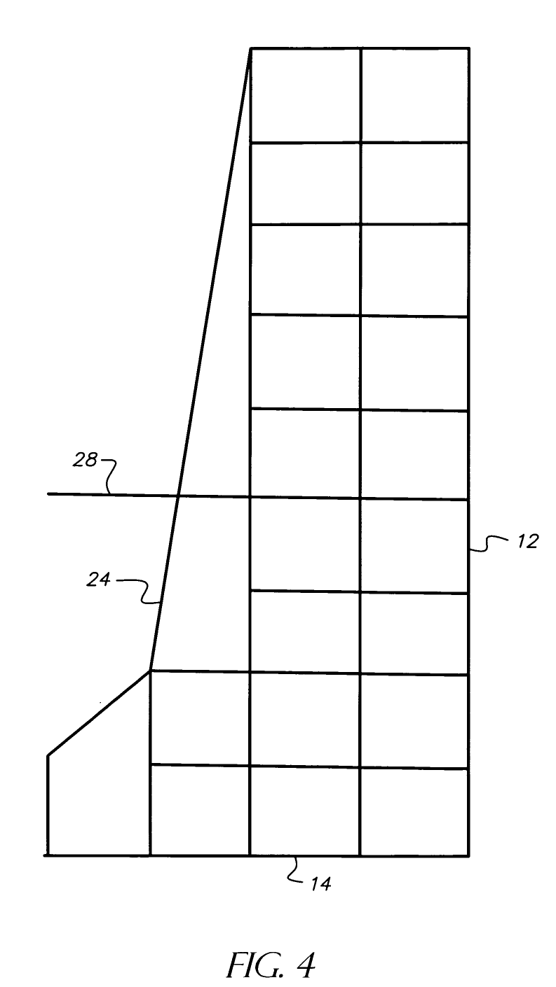

FIG. 4 is a right side view of the holder;

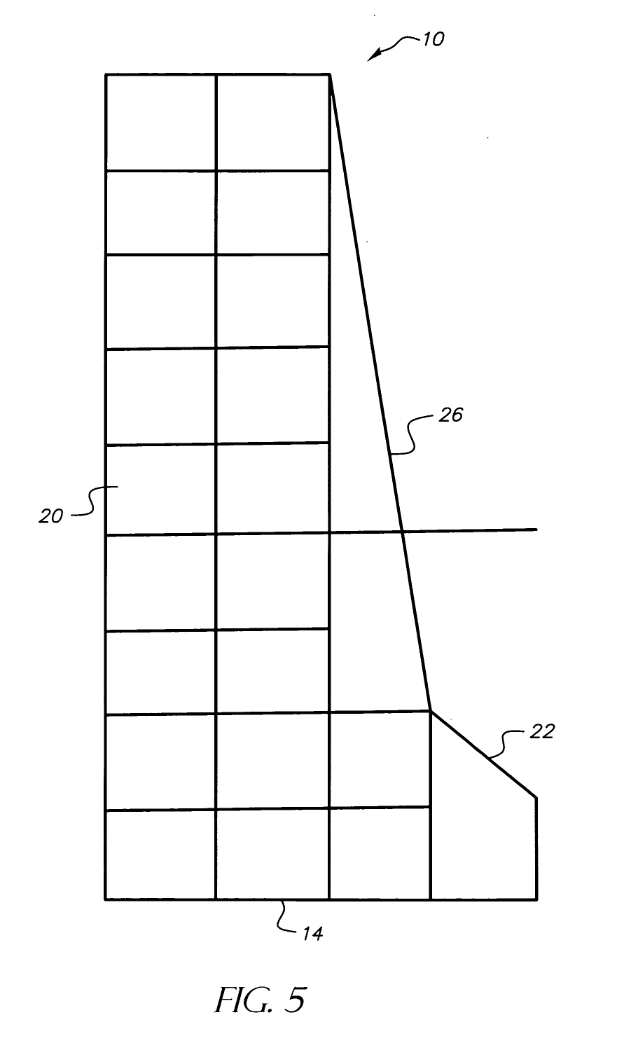

FIG. 5 is a left side view of the holder;

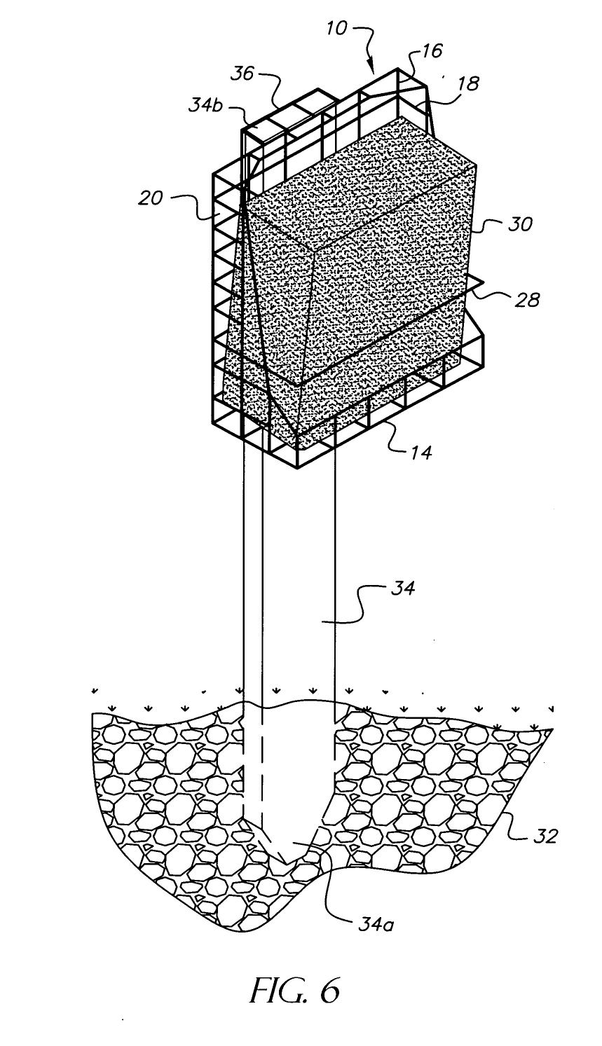

FIG. 6 is a front perspective view showing the assembly of the holder and a stake which is inserted in the ground to hold a block of feed at a desired distance above ground level and at a location where feeding is desirable;

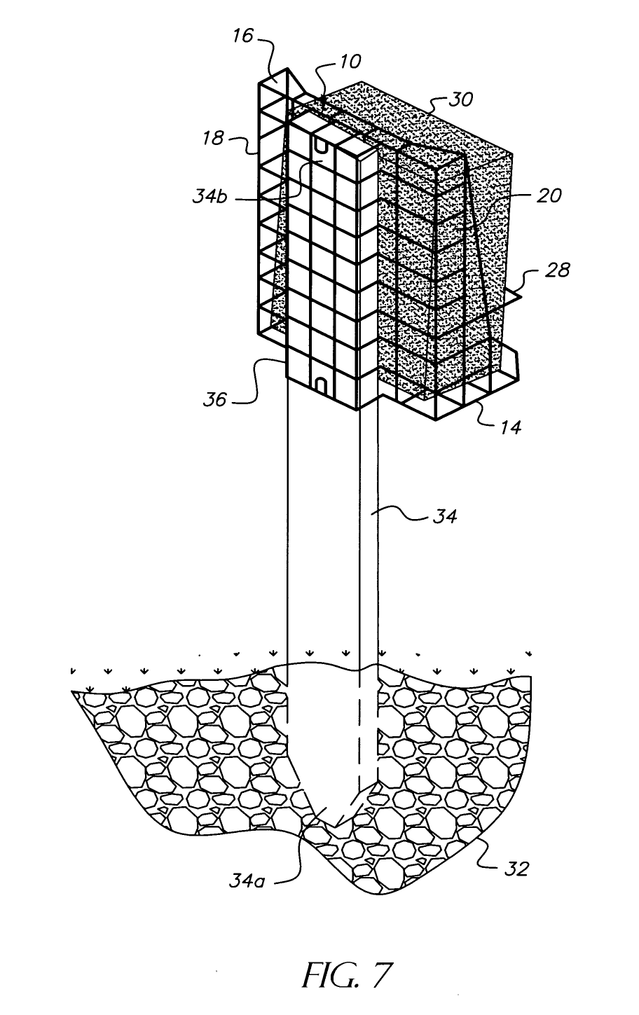

FIG. 7 is a view similar to FIG. 6 but showing the assembly from the rear or back thereof; and

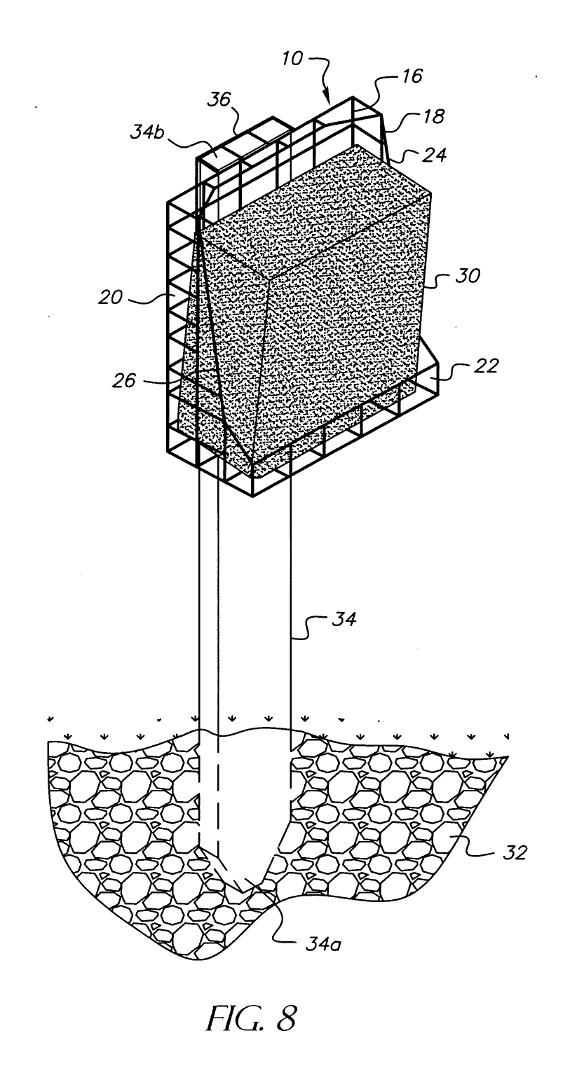

FIG. 8 is a view similar to FIG. 6 where the cage lacks a wire loop brace around the block of animal feed.

Referring to the drawings, there is shown a wire cage or receptacle 10 made up of criss-cross wires of steel. The wires form a back 12, a bottom 14, a top 16, and sides 18 and 20. The top 16 is a lip extending towards the front of the receptacle 10. Wires extending upwardly from the bottom also form a lip 22. The sides 18 and 20 may be extended by wires 24 and 26, respectively, which taper towards the front from the top 16 towards the bottom 14. If desired, a wire loop 28 above the bottom 14 may be provided. This loop 28 is a U-shaped brace extension for securely holding the block 30 of feed as shown, for example, in FIGS. 6 and 7. The receptacle 10 without the loop 28 is shown in FIG. 8.

Into the ground 32 as shown in FIGS. 6, 7, and 8, is one end 34a of a stake 34. The other end 34b of stake 34 is held in a stake supporting receptacle 36 which is attached to the back 12 of the main receptacle 10. This receptacle 36 is closed by wires 38 at the top thereof and is open at the bottom thereof so that the stake 34 can be securely fit and received into the receptacle 36. The receptacle 36 is made of the same criss-cross wires as those from which the main receptacle 10 is formed. The receptacle 36 may extend the entire length of the generally rectangular main receptacle 10 so as to provide a firm support for the stake. Also, the cross-section of the receptacle 36 and the cross-section of the stake 34 are complimentary so the stake can easily slide into the receptacle 36. If desired, wire loops 42 may be provided for nailing or hanging the receptacle 10, in which case, the facilities for the stake 34 are not used.

Double wires for additional strength may be provided along the edges of the bottom 14 and the back 12, if desired.

The stake 34 may be made of wood, metal, or plastic, and preferably has a lower end 34a pointed to facilitate mounting in ground 32. Although the term stake is used, the stake 34 may be any rigid or substantially rigid member (e.g., shaft) having a length between its opposing ends 34a and 34b to locate receptacle 10 at a position (or height) suitable for feeding one or more animals when end 34a is fixed into the ground 32, in which the upper end of such member is a cross-sectional shape and size to enable engagement along the interior of receptacle 36. The ground 32 being the means for supporting the assembly of stake 34 and its receptacle 36 coupled to receptacle 10. Alternatively, the end 34a of the stake 34 may be fixed to other support means as needed based on the environment of use of the receptacle 10, e.g., between rocks or other natural features that may be above, at, or below, ground level, or attached or extending from a post. The receptacles 10 and 26 are preferably of wire coated or layered with another material, e.g. plastic or rubber, but receptacles 10 and 26 may be made of other material, such as of plastic. In operation, the end 34a of stake 34 is mounted in ground 32, and end 34b of stake 34 mounted or received in receptacle 36, such that receptacle 10 is held with a body of feed 30 above the ground 32 at a desired height to facilitate animal feeding, observation of the animals, and access to such animal(s) while feeding in a location.

Variations and modifications in the herein described holder and assembly of holder and stake, within the scope of the invention will undoubtedly suggest themselves to those skilled in the art. Accordingly, the foregoing description should be taken as illustrative and not in a limiting sense.

What is claimed is:

1. An assembly for holding a body of animal feed which comprises a wire cage having a bottom, a back, and an open front defined by sides extending upwardly along said base and said back to form a receptacle for said body which exposes said body for feeding thereon by an animal, a stake for supporting said receptacle above ground surface, a receptacle for said stake provided by wires disposed along said back and having an open end at the bottom thereof, a closed end at the top thereof and a cross-section complimentary a cross-section of said stake.

2. The assembly of claim 1 wherein said cage has a wire loop above said bottom and extending away from said sides toward the front of the cage to provide a brace for said body closer to the bottom of said body than the top thereof.

3. The assembly of claim 1 wherein said loop has a U-shape.

4. The assembly of claim 1 wherein the said cage has lips extending upwardly from said bottom and along said sides and said top defined by wires of said cage.

5. The assembly of claim 4 wherein the wires defining the front of said lips along said sides are inclined and taper outwardly from said top toward said front at said bottom so as to increase the width of said sides.

6. The assembly of claim 1 wherein said stake has a tapered bottom which penetrates the ground and a flat top which engages the wires at the top of the receptacle for the stake.

7. The assembly of claim 1 wherein said wire cage is generally rectangular in shape and the wires of said cage are perpendicular to each other and cross to define said back, said bottom and said receptacle for said stake.

8. A holder for a body of animal feed comprising:
a wire cage having a bottom, a back, and an open front defined by sides extending upwardly along said base and said back to form a receptacle for a body of animal feed which exposes the body for feeding thereon by an animal; and
a receptacle for a stack for supporting the body above ground surface, said receptacle for said stake being provided by wires disposed along said back and having an open end at the bottom thereof, a closed end at the top thereof, and a cross-section complimentary a cross-section of said stake.

9. The holder of claim 8 wherein said cage has a wire loop above said bottom and extending away from said sides toward the front of the cage to provide a brace for said body closer to the bottom of said body than the top thereof.

10. The holder of claim 8 wherein said loop has a U-shape.

11. The holder of claim 8 wherein the said cage has lips extending upwardly from said bottom and along said sides and said top defined by wires of said cage.

12. The holder of claim 11 wherein the wires defining the front of said lips along said sides are inclined and taper outwardly from said top toward said front at said bottom so as to increase the width of said sides.

13. The assembly of claim 8 wherein said receptacle for said stake has an open bottom and a closed flat top which engages the top of the stake.

14. The holder of claim 8 wherein said wire cage is generally rectangular in shape and the wires of said cage are perpendicular to each other and criss-cross each other to define said back, said bottom and said receptacle for said stake.

15. A holder for a body of animal feed comprising:
a first means for receiving a body of animal feed;
a member having a first end and a second end opposite said first end; and
a second means, coupled to said first means, for receiving said first end of said member, and said first end extends a length from said second end to locate said a first means at a position suitable for feeding one or more animals when said second end is fixed to a support means.

16. A method for holding a body of animal feed which comprises the steps of:
providing a member having two ends and a length between said ends;
providing an assembly having a first receptacle for receiving a body of animal feed and a second receptacle for receiving a first of said ends of said member; and
mounting the other end of said member into the ground in which said length is sufficient to locate at first receptacle at a height above the ground.
